(19) United States
(12) Patent Application Publication
(10) Pub. No.: US 2014/0002455 A1
(43) Pub. Date: Jan. 2, 2014

(54) Systems and Methods for the Construction of Closed Bodies During 3D Modeling

(71) Applicants: Scott David SENFTEN, Sugar Land, TX (US); David HAWKINS, Houston, TX (US); Charles SEMBROSKI, Katy, TX (US); Philip NORLUND, Houston, TX (US)

(72) Inventors: Scott David SENFTEN, Sugar Land, TX (US); David HAWKINS, Houston, TX (US); Charles SEMBROSKI, Katy, TX (US); Philip NORLUND, Houston, TX (US)

(21) Appl. No.: 13/978,541

(22) PCT Filed: Jan. 7, 2011
(86) PCT No.: PCT/US2011/020485

§ 371 Date: Sep. 23, 2013

(51) Int. Cl. G06T 17/00

(52) U.S. Cl. CPC G06T 17/00
USPC 345/420

(57) ABSTRACT

Systems and methods for the construction of closed bodies from incomplete interpretations of geologic structures during geophysical modeling.

### CROSS-REFERENCE TO RELATED APPLICATIONS

Not applicable.

### STATEMENT REGARDING FEDERALLY SPONSORED RESEARCH

Not applicable.

### FIELD OF THE INVENTION

The present invention generally relates to systems and methods for the construction of closed three-dimensional (“3D”) bodies during modeling. More particularly, the present invention relates to systems and methods for the construction of closed bodies from incomplete interpretations of geologic structures during geophysical modeling.

### BACKGROUND OF THE INVENTION

Modeling specific, individual, geologic bodies, such as a salt body is an important part of the geophysical interpretation process and is critical for constructing realistic models of the subsurface. Modeling geologic bodies, however, presents critical and difficult problems to solve. Salt bodies are inherently difficult to model because the nature of the salt makes the seismic data noisy, poorly defined and thus, difficult to interpret. Also, the nature of salt bodies is that certain surfaces such as the top are often quite clear and thus, can be interpreted quickly using automated tools while capturing the full resolution of the input data compared to other surfaces, such as the sides or bottom, which are less clear and require time consuming manual interpretation and result in lower resolution results. As a result, these interpretation pieces still have to be combined somehow to truly represent the complete 3D geologic body.

Current systems for building representations of complex 3D geologic bodies have several problems. Some systems require an interpreter to manually trace the outline of the geological bodies in a grid like fashion, which then have a skin applied to them. These systems have two serious problems: they are very time consuming and, more importantly, they do not include the highest levels of detail available in the input data. Other systems use a piecemeal approach that stitches input patches together using local fitting and then blend those local approximations to produce a 3D image of a body. As a result, these systems produce an image of a body that is closed but has a surface representation at a level of detail that is equal to the poorest input data. Other systems require the heavy processing of the input data such that the body stands out clearly and thus, can be extracted automatically from the input data. The problem, however, is that most common seismic data can not be processed to a level where these bodies can be easily extracted and thus, manual interpretation is still required.

### SUMMARY OF THE INVENTION

The present invention therefore, overcomes one or more deficiencies in the prior art by providing systems and methods for the construction of closed bodies during 3D modeling.

In one embodiment, the present invention includes a method for constructing a closed body from an input data set during three-dimensional modeling, which comprises: i) determining an orientation for each input point in the input data set; ii) converting each input point and its respective orientation from a native coordinate system to a common coordinate system using a computer processor; and iii) constructing the closed body using each input point and its respective orientation within the common coordinate system.

In another embodiment, the present invention includes a non-transitory program carrier device tangibly carrying computer executable instructions for constructing a closed body from an input data set during three-dimensional modeling. The instructions are executable to implement: i) determining an orientation for each input point in the input data set; ii) converting each input point and its respective orientation from a native coordinate system to a common coordinate system using a computer system; and iii) constructing the closed body using each input point and its respective orientation within the common coordinate system.

Additional aspects, advantages, and embodiments of the invention will become apparent to those skilled in the art from the following description of the embodiments and related drawings.

### BRIEF DESCRIPTION OF THE DRAWINGS

The present invention is described below with references to the accompanying drawings in which like elements are referenced with like reference numerals, and in which:

FIG. 1 is a flow diagram illustrating one embodiment of a method for implementing the present invention.

FIG. 2 is a flow diagram illustrating one embodiment of a method for performing step 104 in FIG. 1.

FIG. 3 is a flow diagram illustrating one embodiment of a method for performing step 108 in FIG. 1.

FIG. 4 illustrates an image of an exemplary data set selected as the input data set in step 102.

FIG. 5 illustrates an image of the data set in FIG. 4 after step 106.

FIG. 6 illustrates an image of the data set in FIG. 4 after step 108.

FIG. 7 is a blocked diagram illustrating one embodiment of a computer system for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present invention are not limited thereto and may also be applied to other industries to achieve similar results.

### Method Description

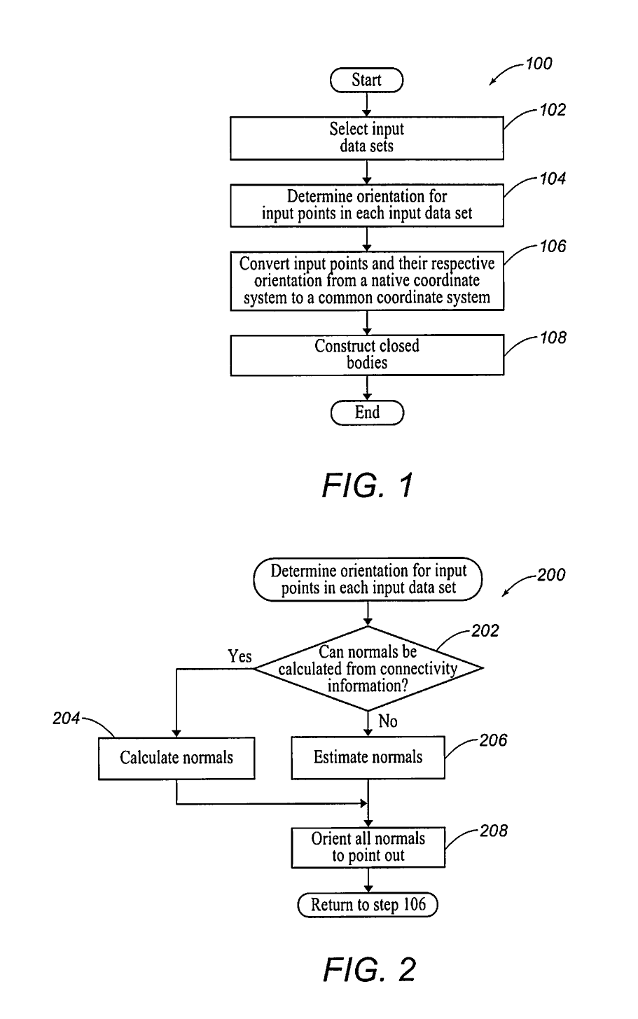

Referring now to FIG. 1, one embodiment of a method 100 for implementing the present invention is illustrated.

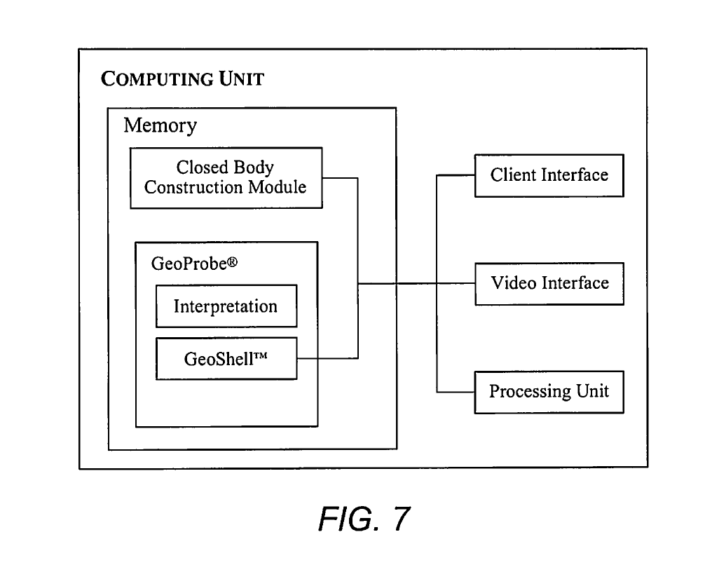

In step 102, one or more input data sets may be selected using the client interface and/or video interface described in reference to FIG. 7. Each data set comprises multiple input points that may define various structures such as horizons and/or faults, for example, that represent part of a larger geologic body. Each input point may, for example, comprise (x,y,z) and (nx,ny,nz) coordinates, where (x,y,z) represents the location of the input point on a continuous geologic body and (nx,ny,nz) represents the direction in which light would reflect off of that location. The direction (nx,ny,nz) in which light would reflect off of a location (x,y,z) is also referred to as a normal. A normal, as used in defining an arithmetic plane in a point-normal equation, defines a direction that is perpendicular to a plane. Each input point therefore, must have a normal that defines the plane in which the input point is included. The input points are incomplete interpretations of an undersampled input data set because sampling is done by an interpreter trying to interpret the body based on noise in the data making the interpretation incomplete. In FIG. 4, an image of an exemplary data set 400 comprising multiple structures (horizons 402, 404, 406, 408 and 410) illustrates one type of data set that may be selected in step 102. The incomplete interpretations are clearly visible in the data set 400 where data is missing and discontinuous.

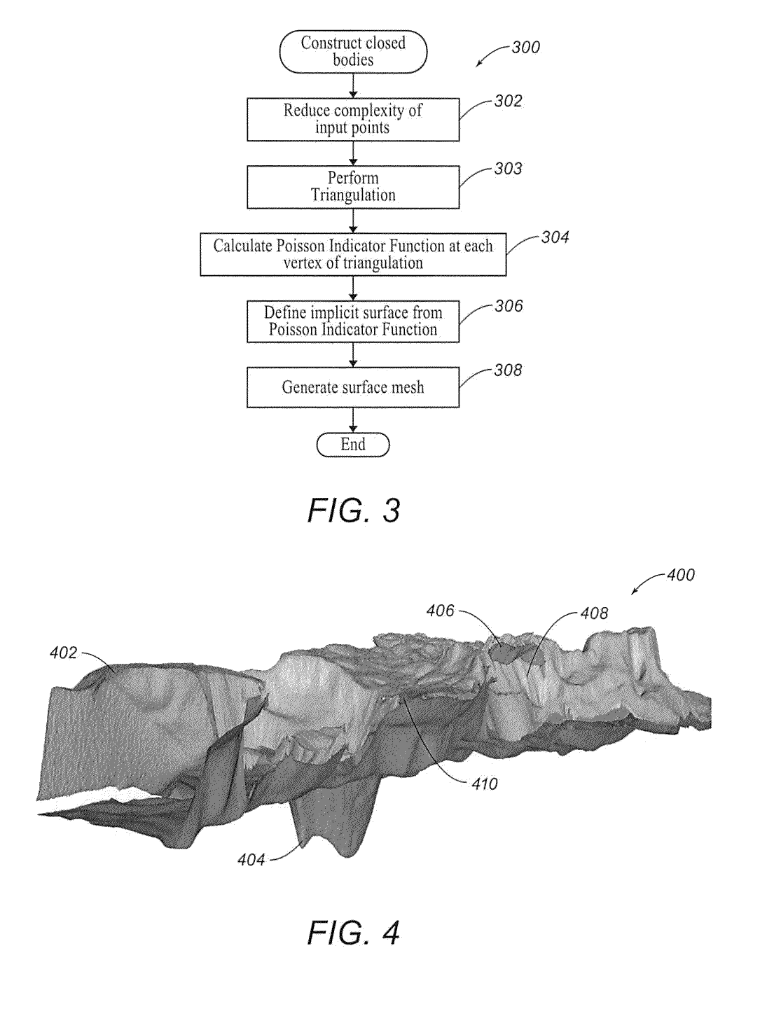

In step 104, the orientation for each input point in each data set is determined using techniques well known in the art. As further illustrated in FIG. 2, the orientation for the input points in each data set may be determined by calculation or estimation using techniques well known in the art. The orientation for the input points in each data set may also be predetermined and used without requiring any calculation or estimation of the same.

Referring now to FIG. 2, a flow diagram illustrates one embodiment of a method 200 for implementing step 104 in FIG. 1.

In step 202, the method 200 determines if normals can be calculated from connectivity information. In mathematical terms, a normal cannot be calculated from a single input point. Depending on how the input point is determined, there may be enough information to calculate a normal. For instance, if the input point is defined on a regular grid (as many geologic horizons are) and has two neighbors also defined, then the equation of the plane and therefore, the normal, can be determined. If the input point for the horizon, fault or other structure is part of a triangle, then there is enough connectivity information to directly calculate a normal for the input point because three connected points define a plane and every plane has a normal. If normals cannot be calculated from connectivity information, then the method 200 proceeds to step 204. If normals can be calculated from connectivity information, then the method 200 proceeds to step 206.

In step 204, normals are calculated for each input point using techniques well known in the art. The normal may be calculated by defining two vectors on a plane with a common start point and performing a cross product on the vectors. Thus, if P1=(x1,y1,z1), P2=(x2,y2,z2) and P3=(x3,y3,z3), then two vectors could be V1=P2−P1 and V2=P3−P1. The normal to the triangle P1,P2,P3 would be N=V 1×V2. For every triangle of which an input point is a member, the normals for each triangle are averaged to obtain a normal for the respective input point. The result is an unoriented normal for each input point.

In step 206, normals are estimated for each input point using techniques well known in the art. The normal may be estimated using a linear least squares fitting of a plane over (k) nearest neighbors where (k) is the number of input point neighbors to search for calculating the plane. The result is an unoriented normal for each input point.

In step 208, each normal is oriented to point out. Each geologic body is represented as a 3D image and has an area inside of its surface and an area outside of its surface. Thus, in this step, each unoriented normal from step 204 or step 206 is oriented to point outside of the body.

The results from step 208 are then returned to step 106 of the method 100, which represent the input points and their respective orientation.

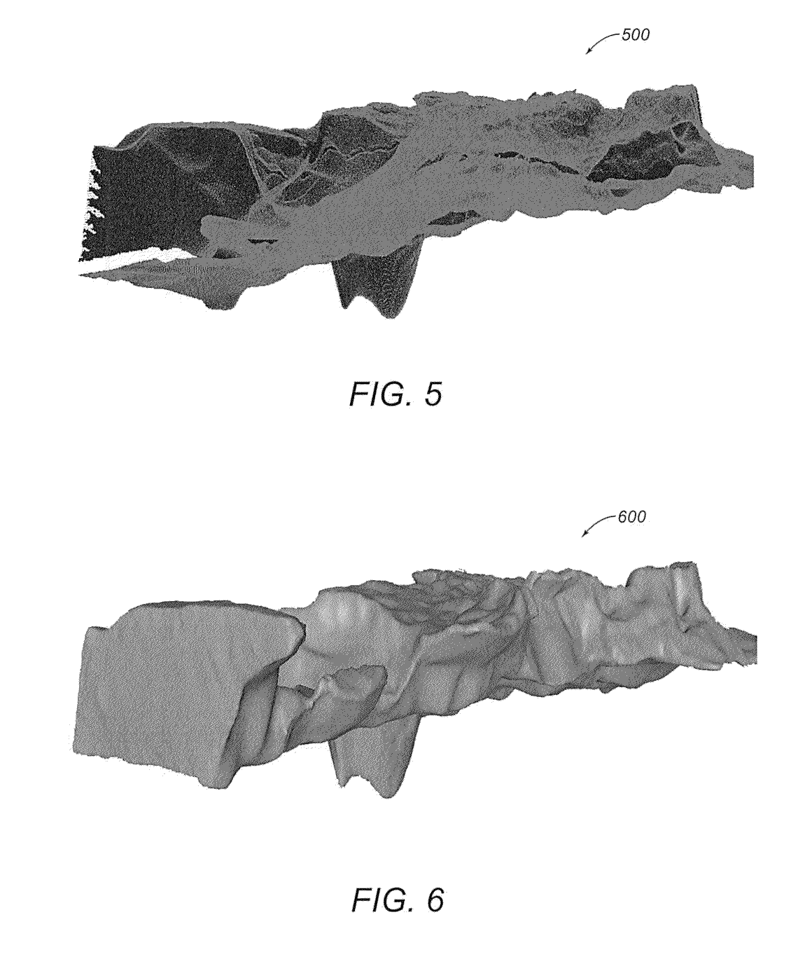

In step 106, the input points, and their respective orientation, for each input data set are converted from their native coordinate system to a common coordinate system using techniques well know in the art. Because the input points may represent various structures (e.g. horizons and/or faults) and the method 100 uses a global approach for all of the input points in each input data set, the location and respective normal for each input point must be converted into a common coordinate system that might differ from the native coordinate system for the input point. Input points and their respective orientation representing a horizon, for example, may be defined locally (i.e. starting at the x,y coordinate of 0,0 or relative to the volume of data on which it was interpreted (i.e. with the origin of the volume starting at 0,0 and the origin of the horizon at some offset from there)). If multiple sets of input points (e.g. two different horizons) have local coordinate systems that are relative to two different data volumes, then data points from one must be converted to the other or both must be converted into a coordinate system that show the relation between each respective coordinate system for the input data sets. The world coordinate system is one example of a common coordinate system, however other coordinate systems may be used by converting all of the input points into world space and then using the centroid of the input points as the origin of another common coordinate system. In FIG. 5, an image of the data set 400 in FIG. 4 is illustrated after the input points and their orientation for the data set are converted from their native coordinate system to a common coordinate system. As a result, the data set 500 in FIG. 5 is composited into a single global data set within a common coordinate system instead of the multiple structures (horizons 402, 404, 406, 408 and 410) represented by the data set 400 in FIG. 4.

In step 108, one or more closed geologic bodies are constructed using the results from step 106 for each respective input data set in step 102 and techniques well known in the art such as, for example, the method 300 described in reference to FIG. 3. In FIG. 6, for example, an image of the data set 400 in FIG. 4 is illustrated after the data missing from the data set 400 are supplied by interpolation to construct a closed salt body 600 using the data set 500 in FIG. 5.

Referring now to FIG. 3, a flow diagram illustrates one embodiment of a method 300 for implementing step 108 in FIG. 1.

In step 302, the complexity of the input points is reduced by reducing the total number of input points using techniques well known in the art. The complexity is reduced to increase the performance the method 100. Although there are a number of techniques well known in the art that may be used, the most simple, and preferred, technique randomly deletes input points. Another alternative technique may be used to create a representative sample from a neighborhood of input points. Other, more complex alternative techniques may be used to: i) simplify the original structures based on curvature; and ii) eliminate input points and their respective normals that do not provide additional information.

In step 303, a triangulation is performed using techniques well known in the art such as, for example, a Delaunay triangulation. Delaunay triangulation for a set of input points P in a Euclidean space is a triangulation DT(P) such that no input point in P is inside the circumhypersphere of any simplex in DT(P). For any 3D space, a Delaunay triangulation is therefore, a triangulation DT(P) such that no input point in P is inside the circum-sphere of any tetrahedron in DT(P). This step is performed across the entire input data set resulting in a set of connected triangles and removes all badly shaped (non isotropic) tetrahedra and tessellates a loose bounding box of the input points.

In step 304, a Poisson Indicator Function is calculated at each vertex of each triangulation from step 303 by solving for a scalar indicator function (f) represented as a piecewise linear function over the triangulation. More specifically, this step solves for the Poisson equation Δf=div(n) at each vertex of each triangulation using a sparse linear solver.

In step 306, an implicit surface is defined from each Poisson Indicator Function calculated in step 304 using techniques well known in the art such as, for example, the techniques used for defining an implicit surface in CGAL, which is a commercial software package available from GeometryFactory.

In step 308, a surface mesh is generated by a simple isosurface extraction using techniques well known in the art such as, for example, a Marching Cubes algorithm. Although the Marching Cubes algorithm is typically used to reconstruct an object in virtual space from data that was sampled in real space using a physical scanning device, a new object is being constructed from incomplete and noisy data using this technique here. As a result, a very smooth surface is constructed that robustly approximates noisy input data and smoothly interpolates areas that are poorly defined by the input data to form a closed body.

The method 100 is a global solution that considers all of the input data without relying on heuristic partitioning or blending. In other words, the method 100 utilizes an input data set representing an incomplete interpretation to construct a closed body during 3D modeling and may be passed on to an interface application for further processing. Steps 303, 304, 306 and 308 may be referred to generally as a Poisson reconstruction.

### System Description

The present invention may be implemented through a computer-executable program of instructions, such as program modules, generally referred to as software applications or application programs executed by a computer. The software may include, for example, routines, programs, objects, components, and data structures that perform particular tasks or implement particular abstract data types. The software forms an interface to allow a computer to react according to a source of input. GeoProbe®, which is a commercial software application marketed by Landmark Graphics Corporation, may be used to interface with the present invention. The software may also cooperate with other code segments to initiate a variety of tasks in response to data received in conjunction with the source of the received data. The software may be stored and/or carried on any variety of memory media such as CD-ROM, magnetic disk, bubble memory and semiconductor memory (e.g., various types of RAM or ROM). Furthermore, the software and its results may be transmitted over a variety of carrier media such as optical fiber, metallic wire and/or through any of a variety of networks such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

Referring now to FIG. 7, a block diagram illustrates one embodiment of a system for implementing the present invention on a computer. The system includes a computing unit, sometimes referred to as a computing system, which contains memory, application programs, a client interface, a video interface and a processing unit. The computing unit is only one example of a suitable computing environment and is not intended to suggest any limitation as to the scope of use or functionality of the invention.

The memory primarily stores the application programs, which may also be described as program modules containing computer-executable instructions, executed by the computing unit for implementing the present invention described herein and illustrated in FIGS. 1-6. The memory therefore, includes a closed body construction module, which enables the method illustrated and described in reference to FIGS. 1-3. Although GeoProbe® may be used to utilize the results of the closed body construction module, other interface applications may be used instead of GeoProbe® or the closed body construction model may be used as a stand alone application. The closed body construction module, therefore, could be implemented as a separate process and communicate to the interface application through any interprocess communication (IPC) mechanism or even a stand alone process that outputs results to some persistent storage device. Additionally, the implementation of the closed body construction module is not required to be implemented as shown. The closed body construction module could be implemented in software or a combination of programmable hardware (e.g., NVIDIA graphics cards via the NVIDIA CUDA software) and software or a combination of software, programmable hardware, and custom built hardware.

Although the computing unit is shown as having a generalized memory, the computing unit typically includes a variety of computer readable media. By way of example, and not limitation, computer readable media may comprise computer storage media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to and/or presently being operated on by the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through application program interface (“API”), which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/non-volatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for constructing a closed body from an input data set during three-dimensional modeling comprising:
determining an orientation for each input point in the input data set wherein each input point comprises coordinates for a location and a direction in which light would reflect off of the location out of the closed body;
converting each input point and its respective orientation from a native coordinate system to a common coordinate system using a computer processor; and
constructing the closed body using each input point and its respective orientation within the common coordinate system.

2. The method of claim 1, wherein each input point comprises (x,y,z) and (nx,ny,nz) coordinates, the (x,y,z) coordinates represents the location of each respective input point on a continuous geologic body and the (nz,ny,nz) coordinates represents the direction in which light would reflect off of the location of each respective input point.

3. The method of claim 2, wherein the (nz,ny,nz) coordinates represents a normal.

4. The method of claim 3, wherein the orientation for each input point in the input data set is determined by calculating the normal and orienting the normal to point out of the closed body.

5. The method of claim 3, wherein the orientation for each input point in the input data set is determined by estimating the normal and orienting the normal to point out of the closed body.

6. The method of claim 3, wherein the normal for each respective input point is predetermined and oriented to point out of the closed body.

7. The method of claim 1, wherein the input data set comprises multiple horizons.

8. The method of claim 7, wherein at least one of the multiple horizons includes a native coordinate system that is the same as a common coordinate system for the multiple horizons.

9. The method of claim 1, wherein the closed body is constructed by reducing a total number of input points in the input data set.

10. The method of claim 9, wherein the closed body is constructed by performing a Poisson reconstruction.

11. A non-transitory program carrier device tangibly carrying computer executable instructions for constructing a closed body from an input data set during three-dimensional modeling, the instructions being executable to implement:
determining an orientation for each input point in the input data set wherein each input point comprises coordinates for a location and a direction in which light would reflect off of the location out of the closed body;
converting each input point and its respective orientation from a native coordinate system to a common coordinate system; and
constructing the closed body using each input point and its respective orientation within the common coordinate system.

12. The method of claim 11, wherein each input point comprises (x,y,z) and (nx,ny,nz) coordinates, the (x,y,z) coordinates represents the location of each respective input point on a continuous geologic body and the (nz,ny,nz) coordinates represents the direction in which light would reflect off of the location of each respective input point.

13. The method of claim 12, wherein the (nz,ny,nz) coordinates represents a normal.

14. The method of claim 13, wherein the orientation for each input point in the input data set is determined by calculating the normal and orienting the normal to point out of the closed body.

15. The method of claim 13, wherein the orientation for each input point in the input data set is determined by estimating the normal and orienting the normal to point out of the closed body.

16. The method of claim 13, wherein the normal for each respective input point is predetermined and oriented to point out of the closed body.

17. The method of claim 11, wherein the input data set comprises multiple horizons.

18. The method of claim 17, wherein at least one of the multiple horizons includes a native coordinate system that is the same as a common coordinate system for the multiple horizons.

19. The method of claim 11, wherein the closed body is constructed by reducing a total number of input points in the input data set.

20. The method of claim 19, wherein the closed body is constructed by performing a Poisson reconstruction.
